(19) United States
(12) Patent Application Publication
(10) Pub. No.: US 2018/0098159 A1
(43) Pub. Date: Apr. 5, 2018

(54) IN-EAR MICROPHONE

(71) Applicant: RADSONE INC., Gyeonggi-do (KR)

(72) Inventors: Chul Jae Yoo, Gyeonggi-do (KR); Woo Suk Lee, Seoul (KR)

(21) Appl. No.: 15/724,633

(22) Filed: Oct. 4, 2017

(30) Foreign Application Priority Data
Oct. 5, 2016 (KR) 1020160128603

(51) Int. Cl. H04R 25/00

(52) U.S. Cl. CPC H04R 25/505; H04R 25/554; H04R 25/405; H04R 25/65

(57) ABSTRACT

Provided is an in-ear microphone. The in-ear microphone includes a microphone unit dimensioned to be inserted into an ear canal and configured to collect a sound and produce an output as an electrical signal, a frequency selecting unit configured to receive the electrical signals, attenuate a signal in a frequency band at or below a first cutoff frequency and output such signal to a first path, and pass a signal at frequencies higher than or equal to a second cutoff frequency to a second path; and an amplifying unit configured to receive a signal from the first path and amplify such signal with a first gain to produce a corresponding output, and receive a signal from the second path and amplify such signal with a second gain to produce a corresponding output, wherein the second cutoff frequency is higher than the first cutoff frequency.

### CROSS-REFERENCE TO RELATED APPLICATION

This application claims priority to and the benefit of Korean Patent Application No. 10-2016-0128603, filed on Oct. 5, 2016, the disclosure of which is incorporated herein by reference in its entirety.

### BACKGROUND

### 1. Field of the Invention

The present invention relates to an in-ear microphone.

### 2. Discussion of Related Art

A microphone is a device that collects a sound and converts the sound into an electrical signal. The microphone generates an electrical signal corresponding to collected sound using electromagnetic induction or a change of capacitance of a capacitor to output the electrical signal. An in-ear microphone is a microphone that is dimensioned to be inserted into an ear canal. A sound generated in vocal cords is transmitted to the ear canal through an oral cavity, eardrums, and the in-ear microphone collects the transmitted sound and converts the sound into an electrical signal.

### SUMMARY OF THE INVENTION

An in-ear microphone collects a sound transmitted to an ear canal through an oral cavity, eardrums and converts the sound into an electrical signal. The sound transmitted to the ear canal through the oral cavity, the eardrums has a characteristic of a frequency which is boosted in a low range and is attenuated at high frequencies. Therefore, when the sound transmitted to the ear canal is collected, a sound in a low frequency band echoes loudly and a sound in a high frequency band is attenuated so that an overall sound to be transmitted is not clearly distinguished and contents to be transmitted cannot be clearly grasped.

The present embodiment is directed to addressing the above-described problem in the related art, and is directed to providing an in-ear microphone capable of overcoming an influence resulting from a sound transmission characteristic in which a sound in a low frequency band is boosted and a sound in a high frequency band is attenuated.

According to an aspect of the present invention, there is provided an in-ear microphone including a microphone unit dimensioned to be inserted into an ear canal and configured to collect a sound and output the sound as an electrical signal, a frequency selecting unit configured to receive the electrical signals, cut a signal at frequencies of a first cutoff frequency or lower to output the so-modified signal to a first path; and pass a signal at frequencies of second cutoff frequency or higher to output the signal to a second path; and an amplifying unit configured to receive a signal from the first path and amplify such signal with a first gain to output this signal, and receive a signal from the second path and amplify such signal with a second gain to output this signal, wherein the second cutoff frequency is higher than the first cutoff frequency.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram schematically illustrating a configuration of an in-ear microphone according to one embodiment;

FIGS. 2A and 2B are diagrams schematically illustrating circuits of a microphone unit;

FIG. 3 is a diagram schematically illustrating a frequency characteristic of a sound collected in an ear canal;

FIG. 4 is a diagram schematically illustrating a configuration of a frequency selecting unit according to one embodiment and a frequency characteristic of an output signal; and

FIGS. 5A and 5B are diagrams schematically illustrating implementation examples of a low cut filter and a high pass filter according to one embodiment.

### DETAILED DESCRIPTION

The descriptions of the present invention are only exemplary embodiments for structural or functional explanation. Therefore, the scope of the present invention is not to be construed as being limited by the embodiments described in this specification. That is, the embodiments can be modified in various ways and take on various alternative forms, and thus it should be understood that the scope of the present invention covers equivalents capable of realizing the technological scope of invention.

Meanwhile, the meanings of the terms described herein should be understood as follows.

As used herein, the singular forms “a,” “an,” and “the” are intended to include the plural forms as well, unless the context clearly indicates otherwise. It should be further understood that the terms “comprise,” “comprising,” “include,” and/or “including,” when used herein, specify the presence of stated features, numbers, steps, operations, elements, components, and/or groups thereof, but do not preclude the presence or addition of one or more other features, numbers, steps, operations, elements, components, and/or.

Steps may be performed differently from the specified order unless the context clearly indicates a specific order in the context. That is, steps may be performed in the same order as specified, may be performed substantially concurrently, or may be performed in a reverse order.

Unless otherwise defined, all terms used herein have the same meaning as commonly understood by one of ordinary skill in the art to which this invention belongs. It should be further understood that terms, such as those defined in commonly used dictionaries, are to be interpreted as having a meaning that is consistent with their meaning in the context of the relevant art and are not to be interpreted in an idealized or overly formal sense unless expressly so defined herein.

In this specification, types of signal lines are not distinguished. Therefore, a data bus may be a single line for transmitting a single ended signal, or may be a line pair capable of transmitting a differential signal. In addition, each of the lines illustrated in the drawings may be interpreted as a single ended signal or a bus signal composed of one or more analog signals or digital signals, and a description thereof may be added as necessary.

In this specification, the terms “boost” a signal or “boosted” signal refer to an amplitude of the signal of a certain frequency band is greater than that of the other frequency bands due to frequency-dependent attenuation of the sound transmission path. Thus the “boosted” signal should be distinguished from a signal formed by being amplified electrically.

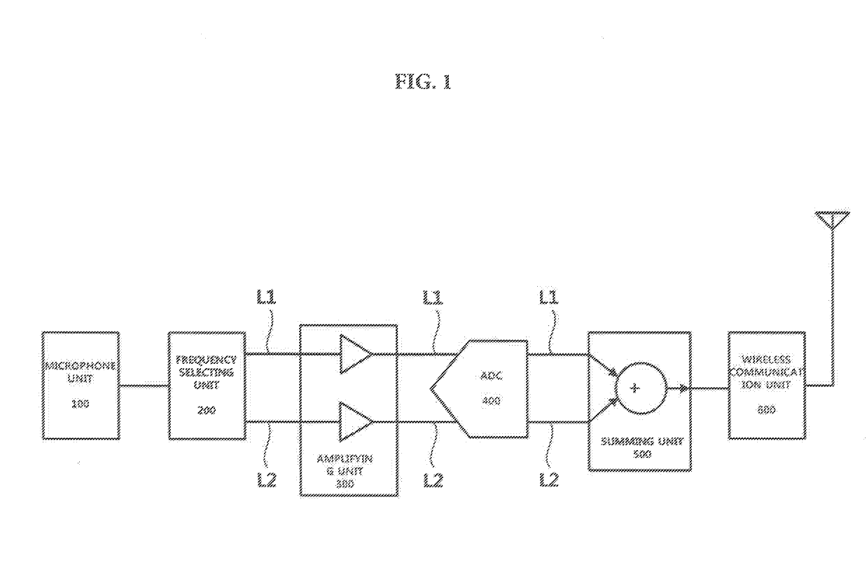

Hereinafter, an in-ear microphone 1 according to one embodiment will be described with reference to the accompanying drawings. FIG. 1 is a block diagram schematically illustrating a configuration of the in-ear microphone 1 according to the present embodiment. Referring to FIG. 1, the in-ear microphone 1 according to the present embodiment includes a microphone unit 100, which is mounted in an ear canal, collects a sound, and outputs the sound as an electrical signal, a frequency selecting unit 200, which receives the electrical signals, cuts a signal in a band having a first cutoff frequency or less to output the signal to a first path L1, and passes a signal in a band having a second cutoff frequency or more to output the signal to a second path L2, an amplifying unit 300, which receives a signal from the first path L1 and amplifies the signal with a first gain to output the signal, and receives a signal from the second path L2 and amplifies the signal with a second gain to output the signal, and an analog-to-digital converter (ADC) 400, which receives the signals output to the first path L1 and the second path L2 by the amplifying unit 300, converts the signals into digital signals, and outputs the digital signals to the respective paths, wherein the second cutoff frequency is higher than the first cutoff frequency.

In one embodiment, the in-ear microphone 1 further includes a summing unit 500 which sums a signal, which is converted into a digital signal and output to the first path L1, and a signal, which is converted into a digital signal and output to the second path L2, and a wireless communication unit 600 which wirelessly transmits a signal output from the summing unit 500.

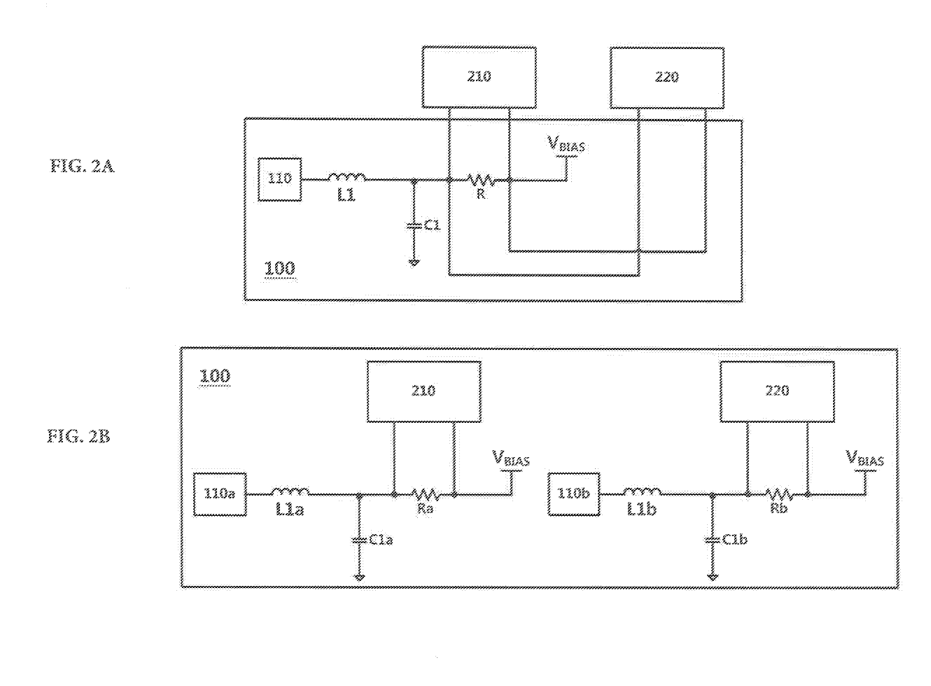

FIGS. 2A and 2B are diagrams schematically illustrating circuits of the microphone unit 100. In the embodiment illustrated in FIG. 2A, the microphone unit 100 includes one sound collecting unit 110. The sound collecting unit 110 collects a sound transmitted from an ear canal to generate an electrical signal corresponding thereto. Filtering is performed on an electrical signal output from the sound collecting unit 110 by a filter including L1 and C1, and a differential signal is formed using a resister R and provided to the frequency selecting unit 200.

Referring to FIG. 2B, the embodiment of the microphone unit 100 includes two sound collecting units 110a and 110b. For example, each of the sound collecting units 110a and 110b may collect a sound transmitted from an ear canal. As another example, one sound collecting unit 110a may be configured to collect a sound transmitted to the ear canal and the other sound collecting unit 110b may be configured to be located outside the ear canal to collect, in operation, a sound along an acoustic path that is different from the acoustic path characterizing the operation of the microphone unit of FIG. 1. Each of the sound collecting units 110a and 110b generates an electrical signal corresponding to the collected sound and provides the electrical signal to the frequency selecting unit 200.

In the embodiments illustrated in FIGS. 2A and 2B, the embodiment of the filter is shown to include L1 and C1 only as an example, and in general may be a filter, such as a shelving filter, a band pass filter, a band stop filter, a high pass filter, a low pass filter, or the like, which is implemented as a primly filter or a secondary or higher filter. In the present embodiment, a cutoff frequency and function of a filter including L1a and C1a may be different from a cutoff frequency and function of a filter including L1b and C1b. Also, resistors Ra and Rb which generate differential signals may have different resistance values.

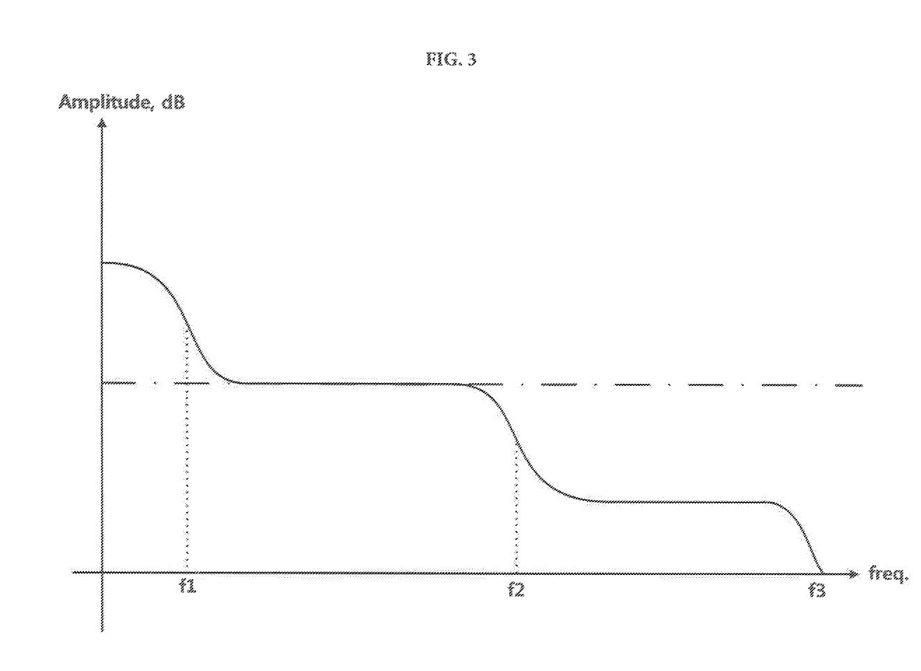

FIG. 3 is a diagram schematically illustrating a frequency characteristic of a sound collected in an ear canal. Referring to FIG. 3, an alternate long and short dashed line illustrates a frequency characteristic of a sound generated in vocal cords, and a solid line illustrates a frequency characteristic of a sound collected in the ear canal. When it is assumed that the sound generated in the vocal cords has a characteristic in which a frequency is flat over the entire band, as illustrated in FIG. 3, a sound collected in the ear canal through an oral cavity, eardrums has characteristics of low frequency band that a low frequency band is boosted and high frequency band that a high frequency band is attenuated, as illustrated by the solid line in FIG. 3.

When it is assumed that a frequency of a boundary between the low frequency band showing a boost characteristic and an intermediate frequency band is f1 and a frequency of a boundary between the high frequency band showing an attenuation characteristic and the intermediate band is f2, f1 is in a range of 100 Hz to 500 Hz and f2 is in a range of 1 KHz to 5 KHz. The frequencies show individual deviation but have the same characteristic through which the frequencies are boosted in the low frequency band and attenuated in the high frequency band.

Hereinafter, for convenience of explanation, a frequency band having a frequency of f1 or less is referred to as a low range, a frequency band having a frequency more than f1 and less than f2 is referred to as a middle range, and a frequency band having a frequency of f2 or more and equal to f3 is referred to as a high range. For example, a frequency at which an amplitude of a sound signal is rapidly attenuated in the high range is about 8 KHz although there is individual deviation.

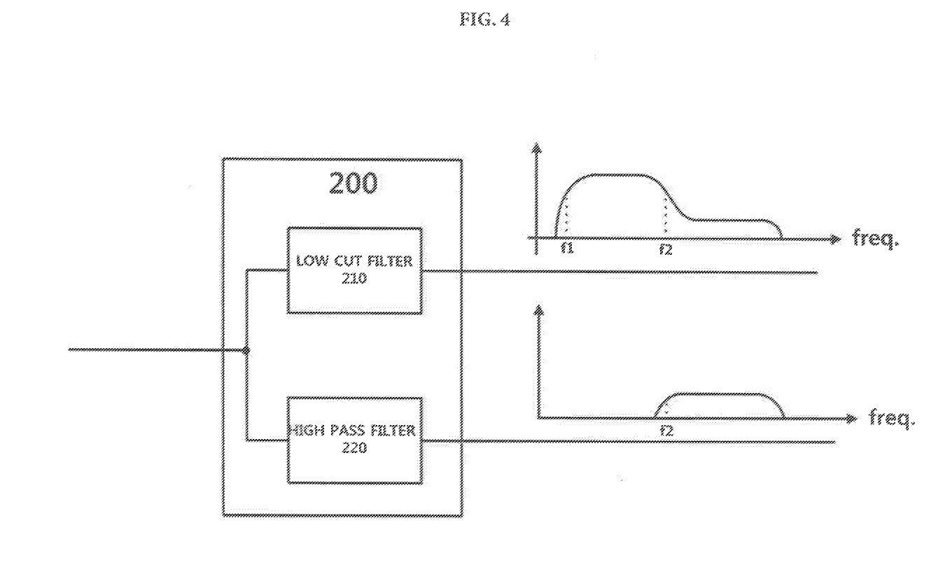

FIG. 4 is a diagram schematically illustrating a configuration of the frequency selecting unit 200 according to the present embodiment and a frequency characteristic of a signal to he output. Referring to FIG, 4, the frequency selecting unit 200 includes a low cut filter 210, which receives a signal from the microphone unit 100, attenuates amplitude in the low range of the received signal, and outputs the signal to the first path, and a high pass filter 220, which passes a portion in the high range of the received signal and outputs the signal to the second path.

The signal provided by the microphone unit 100 is provided to the low cut filter 210 and the high pass filter 220. The low cut filter 210 attenuates amplitude of a low range having a frequency of f1 or less of the provided signal and outputs the signal. In consideration of a frequency characteristic of the signal output from the low cut filter 210, the low cut filter 210 may be designed so that an amplitude of a signal in the low range is smaller than an amplitude of a signal in the middle range as illustrated in FIG. 4. The high pass filter 220 passes only a signal in a high range having a frequency of f2 or more of the provided signal.

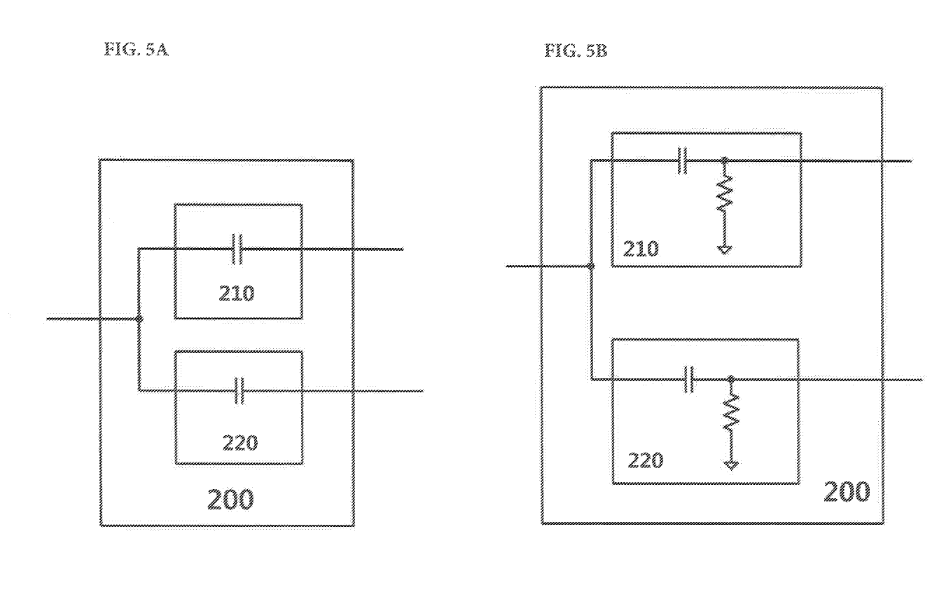

FIGS. 5A and 5B are diagrams schematically illustrating implementation examples of the low cut filter 210 and the high pass filter 220 according to the present embodiment. Referring to FIG. 5A, both the low cut filter 210 and the high pass filter 220 may be implemented as capacitors and may adjust a cutoff frequency by adjusting a capacitance of a capacitor. For example, a capacitance value of a capacitor for implementing the low cut filter 210 is greater than that of a capacitor for implementing the high pass filter 220.

FIG. 5B is a diagram illustrating an example in which both the low cut filter 210 and the high pass filter 220 are implemented as first order resistor-capacitor (RC) filters. A cutoff frequency of the low cut filter 210 is designed to be close to f1, which is a boundary frequency in a boosted low range, and a cutoff frequency of the high pass filter 220 is designed to be close to f2, which is a boundary frequency in an attenuated high range.

In one embodiment, although not illustrated, the low cut filter 210 and the high pass filter 220 may be implemented as second order or higher order filters. In another embodiment, the low cut filter 210 and the high pass filter 220 may be implemented as active filters.

Referring again to FIG. 1, the amplifying unit 300 amplifies the signals, which are input from the first path L1 and the second path L2, with respective amplifiers. The respective amplifiers included in the amplifying unit 300 amplify the signals to match an input dynamic range of the ADC 400 and output the amplified signals to the ADC 400 through the first path L1 and the second path L2. The amplifying unit 300 amplifies the signals with different gains so that the signal provided from the first path L1 and the signal provided from the second path L2 have a signal level corresponding to the input dynamic range of the ADC 400, and outputs the amplified signals. In one embodiment, the amplifying unit 300 adjusts the gains so that an amplitude of the signal output to the first path L1 for each frequency band and an amplitude of the signal output to the second path L2 for each frequency band are constant.

When the gains of the amplifiers included in the amplifying unit 300 are increased, because echoes formed by reflecting sounds, which are provided by an in-ear speaker, in the ear canal are collected and a poor feeling is provided to a user, there is a limit to increasing the gains. When the gains are reduced, the signal in a high range attenuated in a sound transmission process does not swing to match the input dynamic range of the ADC 400 and is not converted into a digital signal having a high resolution. Further, a signal provided to the second path L2 in a digital domain may be amplified, but quantization noise formed in a signal in a high range having an insufficient resolution may also be amplified as described above. Therefore, according to the present embodiment, after the signal output from the frequency selecting unit 200 is amplified, the amplified signal may be converted into a digital signal and converted into a digital signal having a high resolution.

In one embodiment, the first path L1, the second path L2, and a line which connects the microphone unit 100 to the frequency selecting unit 200 are differential lines. The amplifiers included in the amplifying unit 300 are differential amplifiers. Therefore, noise added to a signal provided to the amplifying unit 300 is excluded in an amplification process.

In another embodiment, signals provided to the first path L1, the second path L2, the microphone unit 100, and the frequency selecting unit 200 are single ended signals, and noise added thereto may be removed in a filtering process of the frequency selecting unit 200.

The summing unit 500 filters digital signals output from the ADC 400, sums the digital signals, and then generates a signal. A signal output from the ADC 400 to the first path L1 includes information on a signal in a low frequency band or an intermediate frequency band, and a signal output from the ADC 400 to the second path L2 includes information on a signal in a high frequency band.

In one embodiment, the summing unit 500 may filter a signal provided from the first path L1 with a low pass filter whose cutoff frequency is f1, filter a signal provided from the second path L2 with a high pass filter whose cutoff frequency is f2, and then restore an original signal by summing output signals of the two filters.

The wireless communication unit 600 outputs a digital signal output from the summing unit 500 using a predetermined wireless communication method. In one embodiment, the wireless communication unit 600 transmits the digital signal using a wireless communication method such as Bluetooth, Wifi, and ZigBee.

In the in-ear microphone according to the present embodiment, signals faithful to a human voice may be restored in spite of a change in frequency characteristics thereof occurring in a sound transmitting process. Because the sound collecting unit of the microphone unit is inserted into an ear canal and collects a sound, external noises are not collected, and a noise characteristic may be improved in comparison to a microphone in which a microphone unit is exposed to the outside. While the invention has been described with reference to exemplary embodiments illustrated in accompanying drawings, these embodiments should be considered in a descriptive sense only, and it should be understood by those skilled in the art that various alterations and equivalent other embodiments may be made. Therefore, the scope of the invention is defined by the appended claims.

What is claimed is:

1. An in-ear microphone comprising:
a microphone unit dimensioned to be inserted into an ear canal and configured to collect a sound and output the sound as an electrical signal;
a frequency selecting unit configured (i) to receive the electrical signal, (ii) to attenuate an amplitude of a first portion of the electrical signal at frequencies equal to or lower than a first cutoff frequency, (iii) to output the portion of the electrical signal to a first path, and (iv) to pass a second portion of the electrical signal at frequencies equal to or higher than a second cutoff frequency to a second path; and
an amplifying unit configured (a) to receive the first portion of the electrical signal from the first path and amplify the first portion of the electrical signal with a first gain to output an amplified first portion of the electrical signal, and (b) to receive the second portion of the electrical signal from the second path and amplify the second portion of the electrical signal with a second gain to output an amplified second portion of the electrical signal,
wherein the second cutoff frequency is higher than the first cutoff frequency.

2. The in-ear microphone of claim 1, wherein the microphone unit includes a first microphone dimensioned to be inserted into the ear canal.

3. The in-ear microphone of claim 2, wherein the microphone unit further includes a second microphone dimensioned to be inserted into the ear canal.

4. The in-ear microphone of claim 2, wherein the microphone unit further includes a second microphone positioned, in operation, to collect sound along an acoustic path that is different from an acoustic path characterizing an operation of the first microphone.

5. The in-ear microphone of claim 1, wherein the frequency selecting unit includes:
a low cut filter configured to receive the electrical signal, to attenuate amplitude of a first portion of the electrical signal at frequencies equal to or lower than the first cutoff frequency, and to output the first portion of the electrical signal to the first path; and
a high pass filter configured to receive the electrical signal, to pass a second portion of the electrical signal at frequencies equal to or higher than the second cutoff frequency, and to output the second portion of the electrical signal to the second path.

6. The in-ear microphone of claim 1, wherein:
the first cutoff frequency is any one of frequencies from 100 Hz to 500 Hz; and
the second cutoff frequency is any one of frequencies from 1 KHz to 5 KHz.

7. The in-ear microphone of claim 1, wherein the frequency selecting unit includes any one selected from a group consisting of an active filter and a passive filter.

8. The in-ear microphone of claim 1, wherein the in-ear microphone further includes:
a summing unit configured to sum the first portion of the electrical signal output to the first path and the second portion of the electrical signal output to the second path; and
a wireless communication unit configured to wirelessly transmit a signal output from the summing unit.

9. The in-ear microphone of claim 1, configured to adjust the first gain and the second gain to maintain constant both (i) an amplitude of the first portion of the electrical signal output to the first path at each frequency and (ii) an amplitude of the second portion of the electrical signal output to the second path at each frequency.

10. The in-ear microphone of claim 1, wherein the in-ear microphone further includes an analog-to-digital converter configured to receive the first and second portions of the electrical signal output to the first path and the second path, respectively, by the amplifying unit, to convert received first and second portions into digital signals, and output the digital signals to respective paths.
